(19) United States
(12) Patent Application Publication
(10) Pub. No.: US 2014/0293196 A1
(43) Pub. Date: Oct. 2, 2014

(54) METHOD FOR PRODUCING POLARIZING ELEMENT, POLARIZING ELEMENT, LIQUID CRYSTAL DISPLAY DEVICE, AND ELECTRONIC APPARATUS

(71) Applicant: Seiko Epson Corporation, Tokyo (JP)

(72) Inventor: Yoshitomo KUMAI, Okaya-shi (JP)

(73) Assignee: Seiko Epson Corporation, Tokyo (JP)

(21) Appl. No.: 14/208,362

(22) Filed: Mar. 13, 2014

(30) Foreign Application Priority Data
Mar. 26, 2013 (JP) 2013-064425

(51) Int. Cl. G02F 1/1335; G02B 5/30

(52) U.S. Cl. CPC G02F 1/133528; G02B 5/30
USPC 349/96; 359/483.01; 427/163.1

(57) ABSTRACT

A method for producing a polarizing element includes: forming a moth-eye structure on one surface of a base material; forming a dielectric thin film, in which metal nanoparticles are dispersed, on the moth-eye structure of the base material; and forming a polarizing layer on the base material by stretching the base material so as to stretch the metal nanoparticles thereby forming acicular metal particles.

### BACKGROUND

1. Technical Field

The present invention relates to a method for producing a polarizing element, a polarizing element, a liquid crystal display device, and an electronic apparatus.

2. Related Art

As one type of polarizing element, a polarizing glass is known. A polarizing glass can be composed only of an inorganic substance, and therefore, as compared with a polarizing plate containing an organic substance, the deterioration thereof due to light is significantly less. Therefore, a polarizing glass has drawn attention recently as an effective optical device in a liquid crystal projector whose brightness has been enhanced.

As a general polarizing glass, those described in JP-A-56-169140 are known, and a method for producing such a polarizing glass is as follows.

(1) A glass product having a desired shape is produced from a composition containing silver and at least one halide selected from the group consisting of chlorides, bromides, and iodides.

(2) The produced glass product is heated to a temperature which is higher than the strain point but not higher than the softening point of the glass by about 50° C. for a period of time sufficient to produce crystals of AgCl, AgBr, or AgI in the glass product, whereby a crystal-containing product is produced.

(3) The resulting crystal-containing product is stretched under stress at a temperature which is higher than the annealing point but lower than a temperature at which the glass has a viscosity of about 108 poises so that the crystals are stretched to have an aspect ratio of at least 5:1.

(4) The stretched product is exposed to a reducing atmosphere at a temperature which is higher than about 250° C. but not higher than the annealing point of the glass by about 25° C. for a period of time sufficient to develop a chemically reduced surface layer on the product. By this process, at least a portion of the stretched silver halide particles are reduced to elemental silver.

According to the above-described related art, a metal halide deposits uniformly in the glass product, however, in the reduction step, only the metal halide in the surface layer of the glass product can be reduced, and therefore, the metal halide remains in a central portion in the thickness direction of the glass product. Due to this, the transmittance of the polarizing element is decreased.

The above-described related art has a problem that the process is complicated because, for example, when an antireflection film is formed on the polarizing element, the antireflection film is required to be separately formed using a vapor deposition method or the like after the stretching step.

### SUMMARY

An advantage of some aspects of the invention is to provide a polarizing element having excellent optical properties and a method for producing the polarizing element. Another advantage of some aspects of the invention is to provide a liquid crystal display device having excellent display quality by using such a polarizing element. Still another advantage of some aspects of the invention is to provide an electronic apparatus including this type of liquid crystal display device.

A method for producing a polarizing element according to an aspect of the invention includes: forming a moth-eye structure on one surface of a base material; forming a dielectric thin film, in which metal nanoparticles are dispersed, on the moth-eye structure of the base material; and forming a polarizing layer on the base material by stretching the base material so as to stretch the metal nanoparticles thereby forming acicular metal particles.

According to the method for producing a polarizing element of the aspect of the invention, the dielectric thin film formed on the moth-eye structure is configured such that the moth-eye structure is transferred to the surface thereof. Therefore, an antireflection function can be imparted to the surface without forming an antireflection film on the polarizing element. Accordingly, a polarizing element which exhibits desired optical properties because of having an antireflection function can be easily produced.

The method for producing a polarizing element according to the aspect of the invention may be configured such that the metal nanoparticles are composed of a metal halide, and the method further includes reducing the metal nanoparticles.

According to this configuration, acicular metal particles composed only of a metal can be easily and reliably obtained by the reduction step while the temperature at which the base material is heated in the stretching step is decreased.

The method for producing a polarizing element according to the aspect of the invention may be configured such that in the formation of the dielectric thin film, a metal material and a dielectric material are simultaneously deposited on the base material.

According to this configuration, a dielectric thin film can be simply formed.

A polarizing element according to another aspect of the invention includes: a base material in which a moth-eye structure stretched in a given direction is formed on one surface thereof; and a polarizing layer, which is formed on the moth-eye structure of the base material, and in which a plurality of acicular metal particles are dispersed in a dielectric material having light transmittance, wherein the polarizing layer has a concavo-convex shape following the moth-eye structure on the surface thereof.

According to the polarizing element of the aspect of the invention, since a concavo-convex shape following the moth-eye structure is formed on the surface of the polarizing layer, an antireflection function can be obtained without additionally forming an antireflection film on the surface of the polarizing element. Accordingly, a high value-added polarizing element capable of exhibiting desired optical properties because of having an antireflection function can be provided.

A liquid crystal display device according to still another aspect of the invention includes: a liquid crystal panel in which liquid crystals are sandwiched between a pair of substrates; and a polarizing element disposed on at least one surface of the liquid crystal panel, wherein the polarizing element is the polarizing element according to the aspect of the invention.

According to the liquid crystal display device of the aspect of the invention, since the liquid crystal display device has the polarizing element according to the aspect of the invention, the liquid crystal display device itself has an antireflection function, and thus, a high display quality is obtained and the reliability is increased.

An electronic apparatus according to still another aspect of the invention includes the liquid crystal display device according to the aspect of the invention.

According to the electronic apparatus of the aspect of the invention, since the electronic apparatus has the liquid crystal display device according to the aspect of the invention, the electronic apparatus itself has a high display quality.

### BRIEF DESCRIPTION OF THE DRAWINGS

The invention will be described with reference to the accompanying drawings, wherein like numbers reference like elements.

FIG. 1 is a cross-sectional view showing a schematic structure of a polarizing element according to a first embodiment.

FIG. 2A is a view showing a relationship between the surface profile of a concavo-convex shape and a refractive index, and FIG. 2B is a view showing a refractive index of a glass surface having no concavo-convex shape.

FIG. 3A is a view showing a shape model of a convex portion used in simulation, and FIG. 3B is a view showing a simplified model of the convex portion.

FIGS. 4A to 4E are graphs showing calculation results of simulation.

FIG. 5A is a view showing a shape model of a convex portion used in another simulation, and FIG. 5B is a view showing a simplified model of the convex portion.

FIGS. 6A to 6C are graphs showing calculation results of simulation.

FIG. 7 is a graph for explaining conditions for a convex portion 21a for obtaining a desired reflectance.

FIG. 8 is a flowchart of a method for producing a polarizing element.

FIGS. 9A to 9C are views for explaining a moth-eye structure forming step.

FIGS. 10A and 10B are views for explaining a dielectric thin film forming step.

FIG. 11 is a view showing a schematic structure of a sputtering apparatus 101 to be used in the dielectric thin film forming step S2.

FIGS. 12A and 12B are views for explaining a stretching step.

FIG. 13 is a flowchart of a method for producing a polarizing element according to a second embodiment.

FIGS. 14A and 14B are views schematically showing a reduction step.

FIG. 15 is a plan view of a liquid crystal display device along with respective constituent elements as viewed from a counter substrate side.

FIG. 16 is a cross-sectional view taken along the line H-H′ in FIG. 15.

FIG. 17 is a perspective view of a cellular phone provided with a liquid crystal display device.

### DESCRIPTION OF EXEMPLARY EMBODIMENTS

Hereinafter, embodiments of the invention will be described with reference to the accompanying drawings.

Incidentally, the scope of the invention is not limited to the following embodiments, and can be arbitrarily changed within the scope of the technical idea of the invention. Further, in the following drawings, in order to make each structure easily understandable, the scale, the number, or the like in each structure is made different from that in the actual structure in some cases.

### First Embodiment

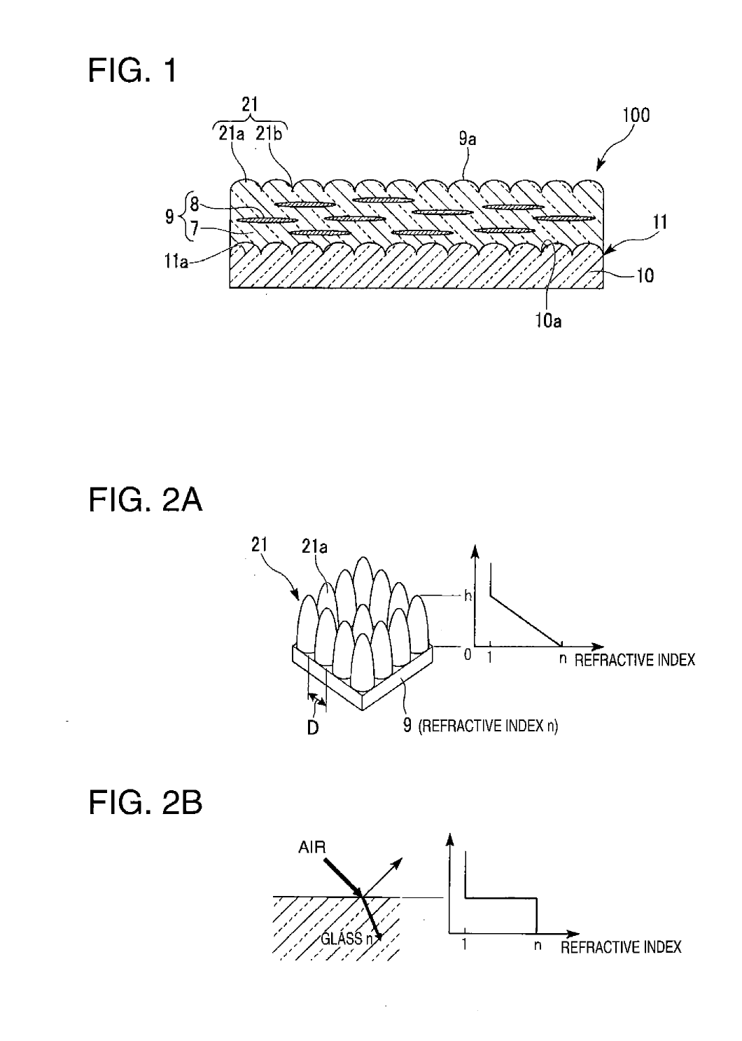

FIG. 1 is a cross-sectional view showing a schematic structure of a polarizing element according to a first embodiment.

As shown in FIG. 1, a polarizing element 100 includes a base material 10 and a polarizing layer 9 laminated on the base material 10. The base material 10 has a moth-eye structure 11 formed on a surface 10a thereof. Here, the moth-eye structure 11 refers to a concavo-convex structure in which portions having a pyramid or cone shape are arranged on the surface of an optical element at a pitch smaller than the wavelength of an incident light.

In this embodiment, the moth-eye structure 11 formed on the base material 10 has a plurality of convex portions 11a. The plurality of convex portions 11a are formed at a pitch of several hundreds of nanometers (for example, about 300 nm). That is, the plurality of convex portions 11a are formed at a pitch smaller than the wavelength range of visible light. Further, the height of each convex portion 11a is set to several tens to several hundreds of nanometers (for example, about 50 to 500 nm). The convex portion 11a has a shape of, for example, a pyramid or a cone such as a rectangular pyramid, a square pyramid, a circular cone, an elliptic cone, or the like in plan view.

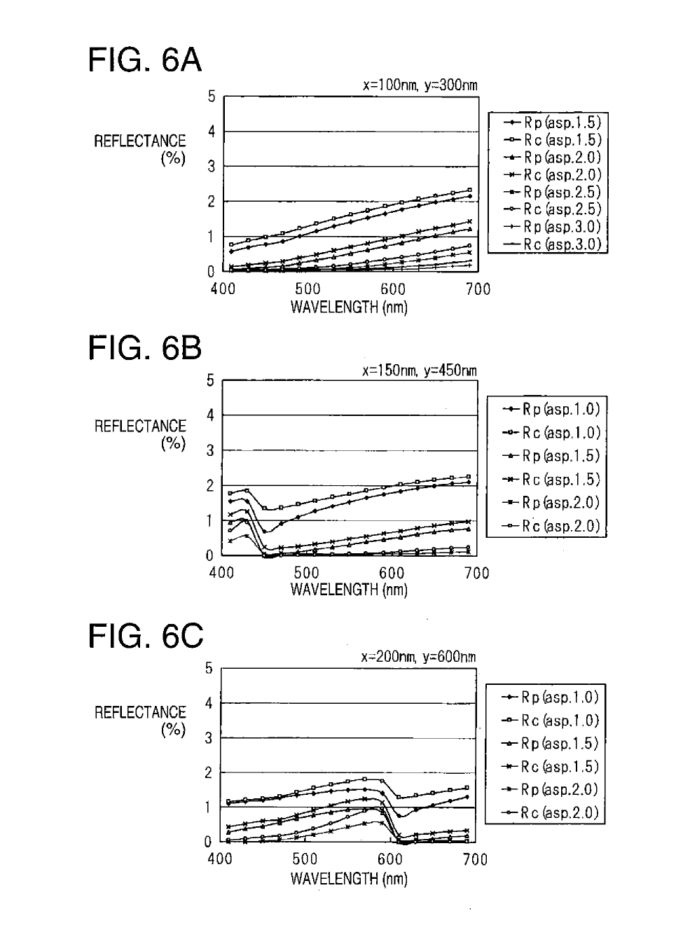

By stretching the moth-eye structure 11 (the convex portions 11a) formed on the surface 10a of the base material 10 along with the base material 10 in a stretching step of a production method, which will be described below, the pitch between the convex portions 11a adjacent to each other is changed (increased in the stretching direction). That is, the moth-eye structure 11 is configured such that the pitch between the convex portions 11a is smaller than the wavelength of visible light as described above even after it is stretched in the stretching step S3 (see FIGS. 6A to 6C).

In this embodiment, the base material 10 is transparent. The base material 10 is not particularly limited, and any known transparent substrate can be used. This is because in the below-described method for producing a polarizing element according to this embodiment, it is not necessary to deposit a metal halide in the base material 10 or introduce a metal ion into the surface of the base material 10 by ion exchange, and therefore, the base material 10 may be any as long as the moth-eye structure 11 can be formed thereon. Specifically, any of various transparent substrates such as quartz glass, soda lime glass, sapphire glass, borosilicate glass, and aluminoborosilicate glass can be used according to the intended use of the polarizing element.

The polarizing layer 9 includes a dielectric layer 7 composed of a dielectric material having light transmittance and a plurality of shape-anisotropic metal particles (acicular metal particles) 8 dispersed in the dielectric layer 7. The shape-anisotropic metal particles 8 have a width narrower than the wavelength of visible light.

In this embodiment, the dielectric layer 7 is composed of, for example, SiO₂, however, the material of the dielectric layer 7 is not limited thereto. As the material of the dielectric layer 7, any material can be appropriately selected as long as it has light transmittance.

The polarizing layer 9 has a concavo-convex shape 21 following the moth-eye structure 11 on the surface 9a opposite to the base material 10. The concavo-convex shape 21 includes a plurality of convex portions 21a protruding upward arranged at a pitch corresponding to that of the convex portions 11a of the moth-eye structure 11 and a plurality of concave portions 21b generated between the plurality of convex portions 21a. That is, the concavo-convex shape 21 is configured such that the pitch between the convex portions 21a adjacent to each other is narrower than the wavelength of visible light. In this specification, for the sake of convenience, the surface of the polarizing layer 9 opposite to the base material 10 is referred to as the upper surface 9a of the polarizing layer 9.

By stretching the concavo-convex shape 21 formed on the upper surface 9a of the polarizing layer 9 along with the base material 10 in the stretching direction in the stretching step of the below-described production method, the pitch between the convex portions 21a adjacent to each other is changed (increased in the stretching direction). Here, since the concavo-convex shape 21 is formed following the moth-eye structure 11, the amount of change in pitch between the convex portions 11a adjacent to each other is considered to be substantially the same as that between the convex portions 21a adjacent to each other. That is, the concavo-convex shape 21 is configured such that the pitch between the convex portions 21a adjacent to each other is smaller than the wavelength of visible light even after it is stretched in the stretching step S3 (see FIGS. 6A to 6C).

The polarizing element 100 according to this embodiment has an antireflection function attributed to the concavo-convex shape 21 formed on the upper surface of the polarizing layer 9.

Here, the antireflection function attributed to the concavo-convex shape 21 will be described. FIGS. 2A and 2B are views for explaining the antireflection function attributed to the concavo-convex shape 21. FIG. 2A is a view showing a relationship between the surface profile of the concavo-convex shape 21 and a refractive index, and FIG. 2B is a view showing a refractive index of a glass surface having no concavo-convex shape as a comparative example.

As shown in FIG. 2A, the polarizing element 100 is configured such that the pitch D between the convex portions 21a adjacent to each other in the concavo-convex shape 21 formed on the upper surface 9a of the polarizing layer 9 is set to a value smaller than the wavelength of visible light. In this case, the refractive index gradually changes from the convex portion 21a to the inner part of the polarizing layer 9.

On the other hand, as shown in FIG. 2B, on the surface of a common glass substrate G having no concavo-convex shape 21 on the surface thereof, the refractive index rapidly changes at the interface between the glass surface and air, and therefore, some light (visible light) is reflected at the interface between the glass surface and air.

In this manner, the polarizing element 100 having the concavo-convex shape 21 on the surface thereof can suppress the reflection of visible light as compared with a common glass substrate since there is no interface at which the refractive index rapidly changes in the polarizing element. That is, the polarizing element 100 has an antireflection function. Therefore, according to the method for producing the polarizing element 100 of this embodiment, a low reflectance with respect also to an incident light having a wide wavelength range or an obliquely incident light can be realized even if an antireflection film is not formed in a later step.

Further, the polarizing element 100 can be used as an optical element exhibiting a function of transmitting a linearly polarized light in a predetermined oscillation direction since the shape-anisotropic metal particles 8 having a width narrower than the wavelength of visible light are arranged at a narrow pitch.

Next, with reference to simulation results, the antireflection effect of the polarizing element 100 will be described. First, simulation results in the case where each convex portion 21a of the concavo-convex shape 21 has a square pyramid shape (the shape of the base thereof is a square) will be described.

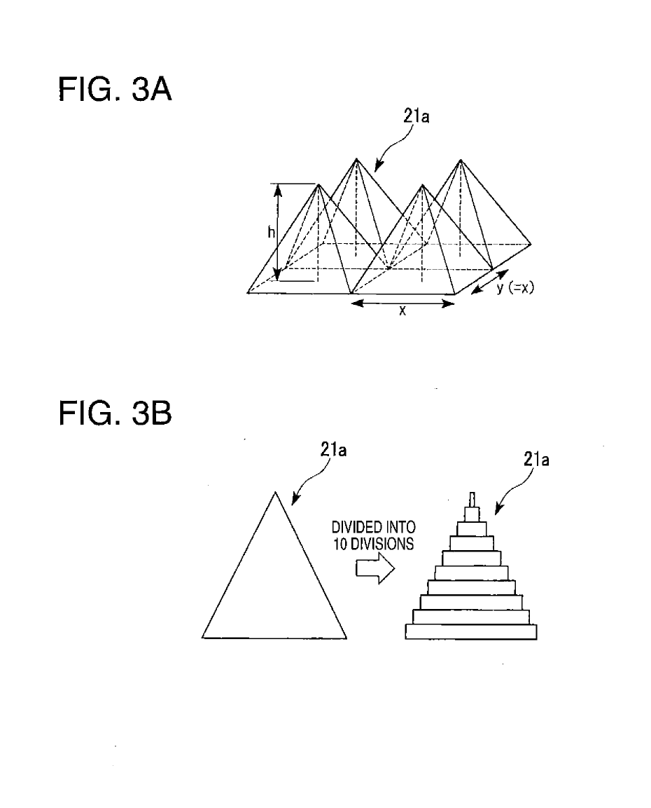

FIG. 3A is a view showing a shape model of the convex portion 21a used in this simulation, and FIG. 3B is a view showing a simplified model of the convex portion 21a.

In this simulation, as shown in FIG. 3A, the height of the convex portion 21a is represented by h, and the lengths of both sides of the base of the rectangular pyramid are represented by x and y, respectively. Incidentally, as shown in FIG. 3A, since the base of the rectangular pyramid has a square shape, the values of x and y are the same.

In this simulation, the reflectance of the surface of the polarizing element 100 was obtained by calculation using an RCWA method (rigorous coupled-wave analysis). In this calculation, the shape of the convex portion 21a was considered to be a square pyramid, and the square pyramid was divided into divisions in the height direction. Further, as the structural parameters, x and h were set, and the reflectance was calculated.

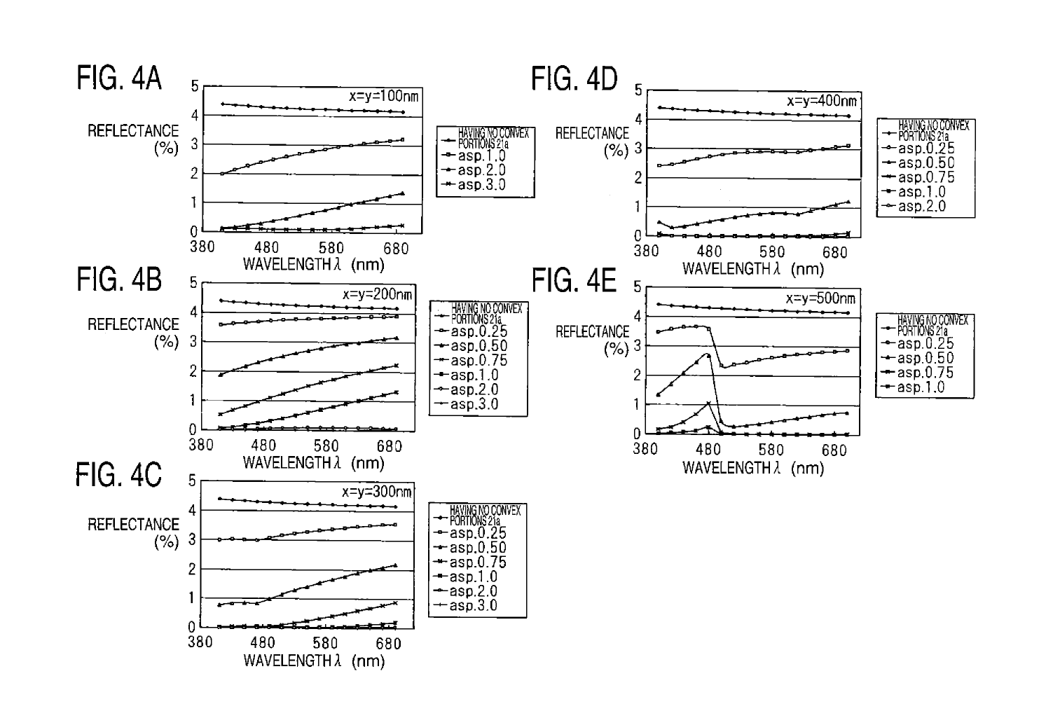

FIGS. 4A to 4E are graphs showing the calculation results of this simulation. The abscissa represents the wavelength (nm) of an incident light, and the ordinate represents the reflectance of the polarizing element 100. Each graph shows the reflectance when the aspect ratio (asp: h/x) was changed. However, the aspect ratio was changed by changing the parameter x while fixing the parameter h at a given value. Further, in each graph, a relationship between the wavelength and the reflectance when the base material had no convex portions 21a is shown for comparison. The parameter x was set to 100 nm in FIG. 4A, 200 nm in FIG. 4B, 300 nm in FIG. 4C, 400 nm in FIG. 4D, and 500 nm in FIG. 4E.

As shown in FIGS. 4A to 4E, in the case where x 500 nm, the reflectance is largely increased in a given wavelength range (for example, in a region less than 500 nm). This is considered to be due to the effect of light diffraction.

Further, a simulation example in the case where the shape of the convex portion 21a is a rectangular pyramid (the shape of the base thereof is a rectangle) will be described.

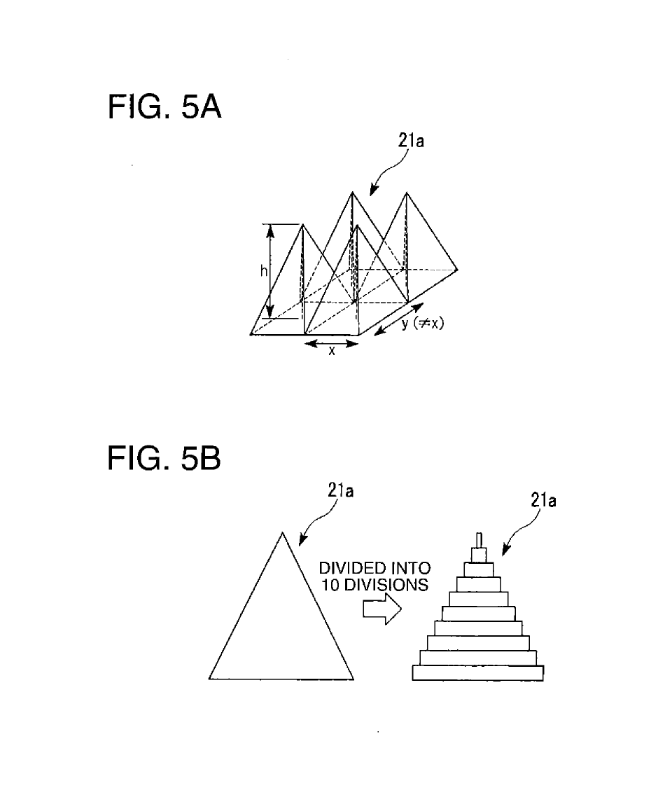

FIG. 5A is a view showing a shape model of the convex portion 21a used in this simulation, and FIG. 5B is a view showing a simplified model of the convex portion 21a.

In this simulation, as shown in FIG. 5A, the height of the convex portion 21a is represented by h, and the lengths of both sides of the base of the rectangular pyramid are represented by x and y, respectively. Incidentally, in this simulation, as shown in FIG. 5A, since the base of the rectangular pyramid has a rectangular shape, the values of x and y are different.

Also in this simulation, the reflectance of the surface of the polarizing element 100 was obtained using an RCWA method by considering the shape of the convex portion 21a to be a rectangular pyramid and dividing the rectangular pyramid into 10 divisions in the height direction. Further, as the structural parameters, x, y, and h were set.

FIGS. 6A to 6C are graphs showing the calculation results of this simulation. The abscissa represents the wavelength (nm) of an incident light, and the ordinate represents the reflectance of the polarizing element 100. Each graph shows the reflectance R_{P} and the reflectance R_{C} when the aspect ratio (asp: h/x) was changed. However, the aspect ratio was changed by changing the parameter x while fixing the parameter h at a given value. Further, the parameter y was changed according to the parameter x so that y/x was 3. Here, R_{P} represents the reflectance of the polarizing element 100 with respect to a TM polarized light among the incident light, and R_{C} represents the reflectance of the polarizing element 100 with respect to a TE polarized light among the incident light.

Incidentally, the parameters x and y were set to 100 nm and 300 nm, respectively, in FIG. 6A, 150 nm and 450 nm, respectively, in FIG. 6B, and 200 nm and 600 nm, respectively, in FIG. 6C.

As shown in FIGS. 6A to 6C, in the case where y>300 nm, the reflectance is largely increased in a given wavelength range due to light diffraction.

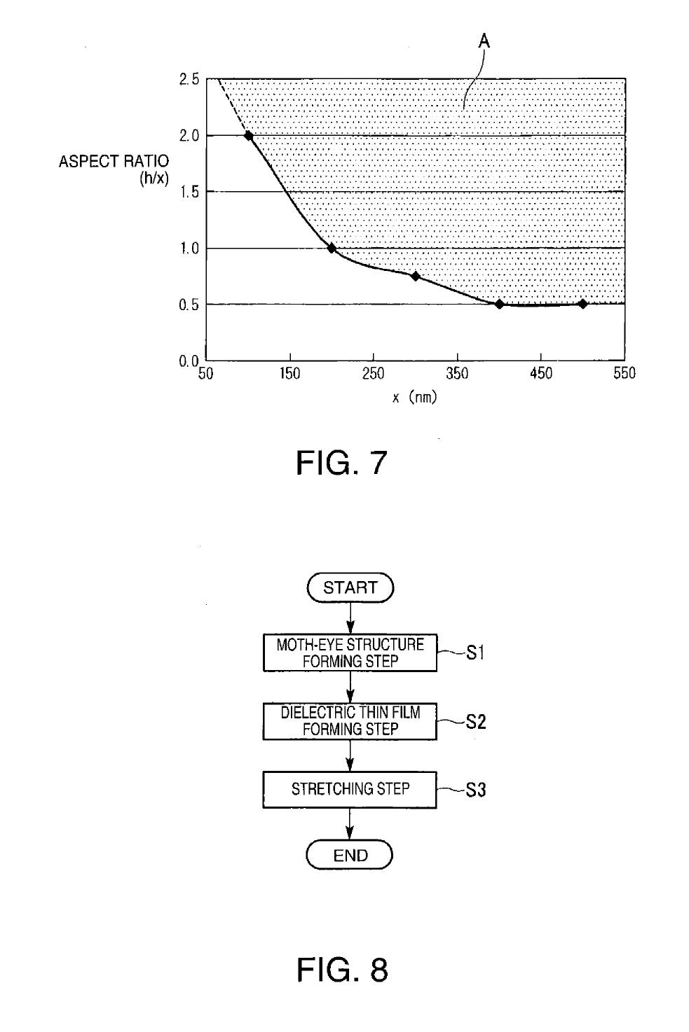

FIG. 7 is a graph for explaining conditions for the convex portion 21a required for obtaining a desired reflectance on the basis of the simulation results shown in FIGS. 4A to 4E. In FIG. 7, the abscissa represents the length x (nm) of one side of a square pyramid, and the ordinate represents the aspect ratio (h/x). Further, as the incident light, a green light was used.

For example, when a reflectance less than 1% is demanded, the convex portion 21a may have a shape which satisfies the conditions falling within the hatched range A in FIG. 7.

Also in the simulation model shown in FIGS. 5A and 5B, by setting the parameters x, y, and h according to the wavelength range to be used and designing the moth-eye structure 11, the reflectance of the polarizing element 100 can be set to a predetermined value.

According to the polarizing element 100 of this embodiment, the concavo-convex shape 21, in which a plurality of convex portions 21a are formed at a pitch smaller than the wavelength of visible light, is formed on the upper surface 9a of the polarizing layer 9, and therefore, a high value-added polarizing element having an antireflection function and excellent optical properties is provided.

Next, a method for producing the polarizing element 100 will be described.

FIG. 8 is a flowchart of a method for producing the polarizing element 100.

As shown in FIG. 8, the method for producing a polarizing element according to this embodiment includes a moth-eye structure forming step S1, a dielectric thin film forming step S2, and a stretching step S3.

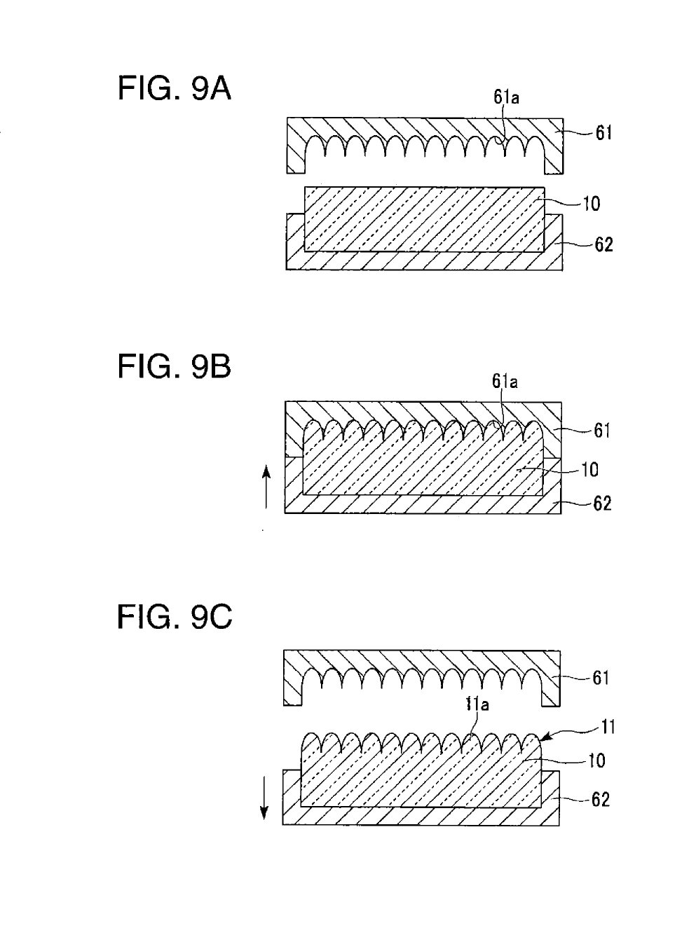

FIGS. 9A to 9C are views for explaining the moth-eye structure forming step S1.

The moth-eye structure forming step S1 is a step of forming a moth-eye structure on the base material 10 by using a nanoimprint technique.

In the moth-eye structure forming step S1, as shown in FIG. 9A, the base material 10, and an upper mold 61 and a lower mold 62 sandwiching the base material 10 are heated to a predetermined temperature in a treatment chamber (not shown). In this embodiment, in order to prevent the oxidation of the surfaces of the upper mold 61 and the lower mold 62 when performing heating, the air in the treatment chamber is replaced with nitrogen in advance. On an inner surface of the upper mold 61 facing the base material 10, concavities and convexities 61a for forming the moth-eye structure are formed. These concavities and convexities have a shape capable of transferring a mold having a pyramid or cone shape (the convex portions 11a) at a pitch smaller than the wavelength of a light described above to the base material 10.

Here, the shape of the concavo-convex shape 21 imparting an antireflection function to the polarizing element 100 depends on the shape of the convex portions 11a of the moth-eye structure 11 before performing the below-described stretching step S3. Therefore, the convex portions 11a of the moth-eye structure 11 can be calculated according to the dimensions, stretching amount, etc. of the convex portions 21a. Accordingly, in the polarizing element 100, the concavo-convex shape 21 (convex portions 21a) capable of obtaining a desired reflectance after stretching is calculated according to the above-described simulation, and an optimal moth-eye structure 11 (convex portions 11a) may be obtained by back calculation.

In this embodiment, as the upper mold 61, a mold in which the concavities and convexities 61a having dimensions capable of forming the moth-eye structure 11 calculated as described above are formed is used.

Subsequently, as shown in FIG. 9B, by moving the lower mold 62 which holds the base material 10 upward, and holding the base material 10 between the upper mold 61 and the lower mold 62 while applying a given pressure thereto for a predetermined time, the concavo-convex shape is formed. In this embodiment, when molding the base material 10, the treatment chamber is vacuumed so that gas does not remain between the base material 10 and the upper mold 61. In this embodiment, by adjusting the holding time and the applied pressure, the transfer ratio of the concavo-convex shape is adjusted to a predetermined value. Further, in the above description, the case where the lower mold 62 is moved upward is shown as an example, however, a configuration in which the upper mold 61 is moved downward or a configuration in which both of the upper mold 61 and the lower mold 62 are moved closer to each other may be adopted.

Subsequently, the molds are separated from the base material 10. In this embodiment, as shown in FIG. 9C, by moving the lower mold 62 downward to a predetermined position, the base material 10 and the upper mold 61 are separated from each other. In this embodiment, the molds are separated from the base material 10 before the temperature of the heated base material 10 is decreased. By doing this, the occurrence of cracking in the base material 10 due to thermal shrinkage can be prevented.

As described above, on the surface (one surface) 10a of the base material 10, the moth-eye structure 11 having a plurality of convex portions 11a is formed. In this manner, the moth-eye structure forming step S1 is completed.

Subsequently, the step proceeds to the dielectric thin film forming step S2 in which a dielectric thin film is formed on the side of the surface 10a of the base material 10. The method for forming the dielectric thin film is not particularly limited as long as it is a method with which a dielectric thin film having a desired thickness can be formed, and either of a gas-phase method and a liquid-phase method may be used. In the case of using a gas-phase method, either of a physical vapor deposition method and a chemical vapor deposition method may be used. Since a film forming species is a metal and the thickness of the formed film is about several nanometers to several tens of nanometers, it is convenient to use a sputtering physical vapor deposition method. Examples of the sputtering physical vapor deposition method include magnetron sputtering, ion beam sputtering, and ECR sputtering.

It is a matter of course that in place of the above-described sputtering physical vapor deposition method, an evaporation physical vapor deposition method such as a vacuum vapor deposition method, a molecular beam vapor deposition method (MBE), an ion plating method, or an ion beam vapor deposition method may be used.

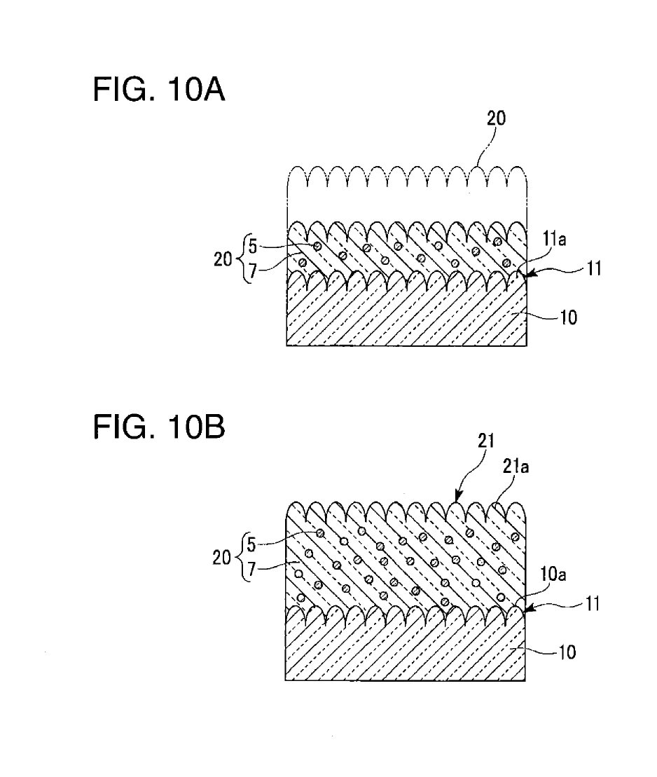

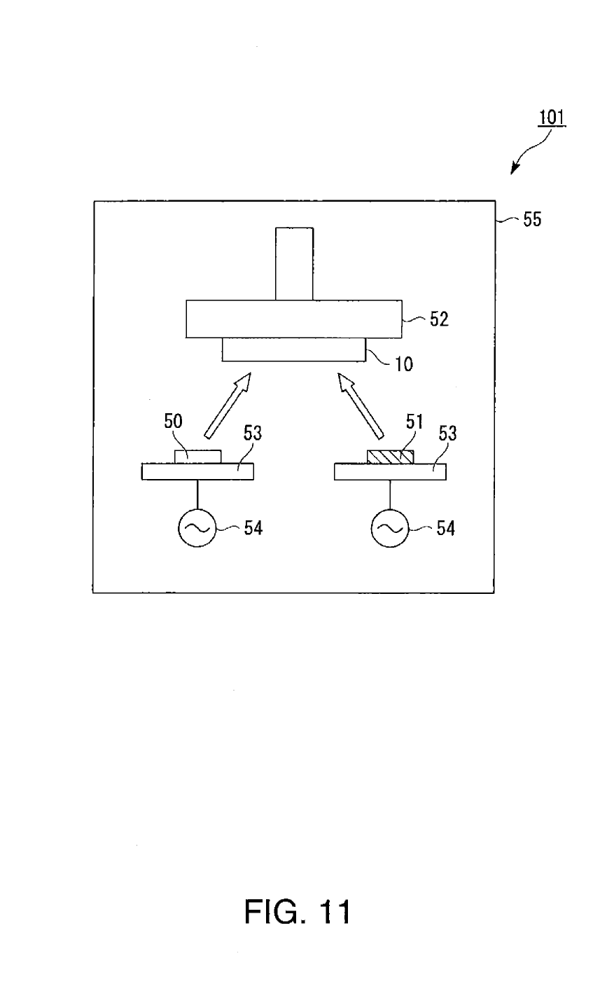

FIGS. 10A and 10B are views for explaining the dielectric thin film forming step S2. FIG. 11 is a view showing a schematic structure of a sputtering apparatus 101 to be used in the dielectric thin film forming step S2.

In this embodiment, in the dielectric thin film forming step S2, the dielectric thin film 20 is formed on the side of the surface 10a of the base material 10 by a sputtering method. As shown in FIG. 11, the sputtering apparatus 101 is configured such that the base material 10, a target 50 composed of a metal (for example, Al), and a target 51 composed of a dielectric material (for example, SiO₂) are placed in a vacuum chamber 55.

The base material 10 is fixed to a substrate holder 52. The targets 50 and 51 are placed at positions facing a surface (surface 10a) of the base material 10, on which the dielectric thin film 20 is to be formed, and fixed to separate target holders 53. To each of the target holders 53, a high-frequency power supply unit 54 is connected.

In this embodiment, in the sputtering apparatus 101, a sputtering gas (for example, Ar) is introduced into the vacuum chamber 55, the interior of which is brought into a vacuum state by a vacuum pump, and a voltage is applied to the targets 50 and 51 by the high-frequency power supply units 54, thereby generating a plasma. Due to the ions in the plasma, a plurality of particles (Al particles) sputtered from the target 50 and a plurality of particles (SiO₂ particles) sputtered from the target 51 are attached to the surface of the base material 10. In this manner, while attaching a plurality of particles (Al particles) sputtered from the target 50 to the surface of the base material 10, a plurality of particles (SiO₂ particles) sputtered from the target 51 are attached to the surface of the base material 10. That is, in the dielectric thin film forming step S2 according to this embodiment, the dielectric thin film 20 is formed by simultaneously depositing a metal material and a dielectric material. By doing this, the dielectric thin film 20 can be formed simply. Incidentally, in this embodiment, the simultaneous deposition of a metal material and a dielectric material means that a step of simultaneously attaching both sputtered materials onto the base material 10 is included in at least a part of the step of forming the dielectric thin film 20. That is, as described below, the dielectric thin film 20 may be formed by including a step of alternately depositing a metal material and a dielectric material as the materials to be deposited onto the base material 10 in the latter half of the film forming step.

The sputtered Al particles and sputtered SiO₂ particles have a small and substantially uniform size, respectively. The sputtered particles attached to the base material 10 aggregate such that the particles composed of the same material aggregate to increase the size. After a predetermined time has passed, the Al particles and the SiO₂ particles aggregate into islands on the base material 10.

In this embodiment, in the sputtering apparatus 101, by changing an electric power to be applied to the target 50 and an electric power to be applied to the target 51 from the high-frequency power supply units 54, the amount of the sputtered particles flying from the target 50 and the amount of the sputtered particles flying from the target 51 per unit time attached to the base material 10 can be adjusted independently.

That is, in the case where an electric power to be applied to the target from the high-frequency power supply unit 54 is increased, the amount of the sputtered particles is increased, and therefore, the amount of the sputtered particles attached to the base material 10 per unit time is increased.

On the other hand, in the case where an electric power to be applied to the target from the high-frequency power supply unit 54 is decreased, the amount of the sputtered particles is decreased, and therefore, the amount of the sputtered particles attached to the base material 10 per unit time is decreased.

In this manner, by adjusting an electric power to be applied to the target 50 and an electric power to be applied to the target 51 from the high-frequency power supply units 54, the ratio of the Al particles flying from the target 50 to the SiO₂ particles flying from the target 51 to be attached onto the base material 10 can be adjusted.

In the sputtering apparatus 101, the adjustment is performed such that when the size of the metal nanoparticles formed by aggregating the Al particles reached a predetermined value, only the SiO₂ particles from the target 51 are selectively attached to the base material 10. By doing this, on the base material 10, as shown in FIG. 10A, the dielectric thin film 20 in which the dielectric layer 7 composed of SiO₂ covers the metal nanoparticles 5 composed of Al is formed.

In this embodiment, the base material 10 has the moth-eye structure 11 formed on the surface 10a. The sputtered particles attached to the base material 10 have a size sufficiently smaller than the size of the convex portion 11a of the moth-eye structure 11. Therefore, the dielectric layer 7 is formed following the concavo-convex shape (the convex portions 11a) of the moth-eye structure 11. Further, in the dielectric layer 7, a plurality of metal nanoparticles 5 are dispersed.

In the sputtering apparatus 101, the dielectric thin film 20 is formed to a thickness of 1 μm on the base material 10 by repeating the step of forming the metal nanoparticles 5 and the step of covering the metal nanoparticles 5 with the dielectric layer 7 a plurality of times. To the thus formed dielectric thin film 20, the concavo-convex shape (the convex portions 11a) of the moth-eye structure 11 is transferred as shown in FIG. 10B, and therefore, the dielectric thin film 20 has a concavo-convex shape 21. In this manner, the dielectric thin film forming step S2 is completed.

In the dielectric thin film forming step S2, for example, as the dielectric layer 7 of the dielectric thin film 20, the same material as that of the base material 10 may be used. In such a case, the dielectric thin film 20 and the base material 10 can be integrated at the interface, and thus, the occurrence of a difference in refractive index at the interface between the dielectric thin film 20 and the base material 10 can be prevented.

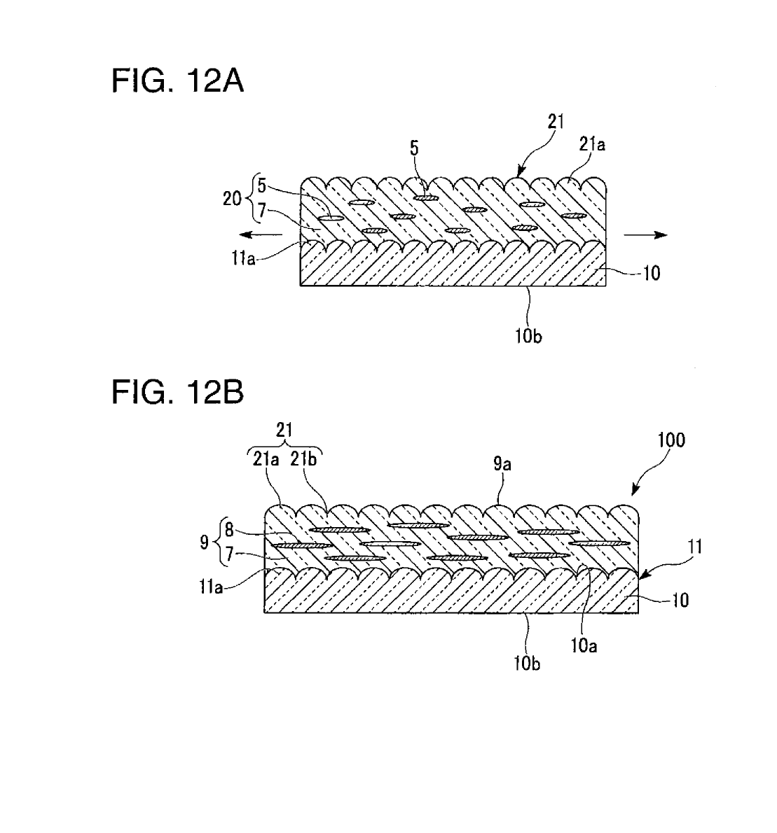

After the dielectric thin film forming step S2, the step proceeds to the stretching step S3. FIGS. 12A and 12B are views for explaining the stretching step S3.

In the stretching step S3, as shown in FIG. 12A, the base material 10 is stretched (elongated) at a temperature at which the base material 10 is softened along a predetermined direction (one direction) among plane directions parallel to the back surface 10b of the base material 10 on which the dielectric thin film 20 is not formed. As the stretching method, a stretching treatment in which the base material 10 is pulled in a direction parallel to the plane may be used. The heating temperature in the stretching step S3 is set according to the material of the base material 10 or the dielectric thin film 20. In the case of this embodiment, the heating temperature is set to a temperature at which the base material 10 can be softened without melting, and the metal nanoparticles 5 can be stretched.

By the stretching step S3, the base material 10 and the dielectric thin film 20 formed on the base material 10 are stretched in the stretching direction and also thinned. Further, the metal nanoparticles 5 dispersed in the dielectric thin film 20 (the dielectric layer 7) are also stretched in the stretching direction. By doing this, in the dielectric thin film 20, as shown in FIG. 12B, a plurality of shape-anisotropic metal particles (acicular metal particles) 8 oriented in the stretching direction of the base material 10 (in the horizontal direction in the drawing) are formed. The shape-anisotropic metal particles 8 have shape anisotropy and have an elongated shape with an aspect ratio of, for example, 5 or more. For example, the particles have a size such that the width is from about 3 to 10 nm and the length is from about 15 to 50 nm.

In a region between the plurality of shape-anisotropic metal particles 8 formed by the stretching step S3, elongated slit-shaped regions as shown in FIGS. 12A and 12B are formed. The size of such a slit-shaped region varies depending on the formation density of the metal nanoparticles 5, however, the region has a width of about 3 to 10 nm and a length of about 15 to 50 nm.

In this manner, the stretching step S3 is completed. According to this production method, the polarizing element 100 in which a lot of shape-anisotropic metal particles 8 are dispersed in the dielectric layer 7 can be produced.

According to the production method of this embodiment described in detail above, by forming the dielectric thin film 20 on the moth-eye structure 11 formed on the surface 10a of the base material 10, the moth-eye structure (the concavo-convex shape 21) can be transferred to the surface of the dielectric thin film 20. Accordingly, an antireflection function as described above can be imparted on the surface without forming an antireflection film on the polarizing element 100. Therefore, the polarizing element 100 which exhibits desired optical properties because of having an antireflection function can be easily produced.

### Second Embodiment

Next, a second embodiment will be described. In this embodiment, the same reference numerals are assigned to the same constituent elements as those in the above-described embodiment, and the description thereof is simplified or omitted.

The different point of this embodiment from the first embodiment is that a reduction step is needed because the configuration of the dielectric thin film 20 is different. Hereinafter, the step of forming the dielectric thin film 20 and the reduction step will be mainly described.

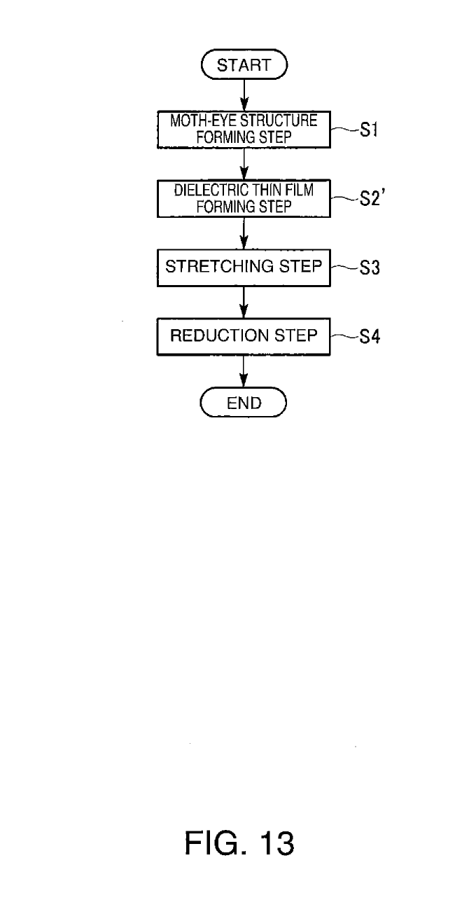

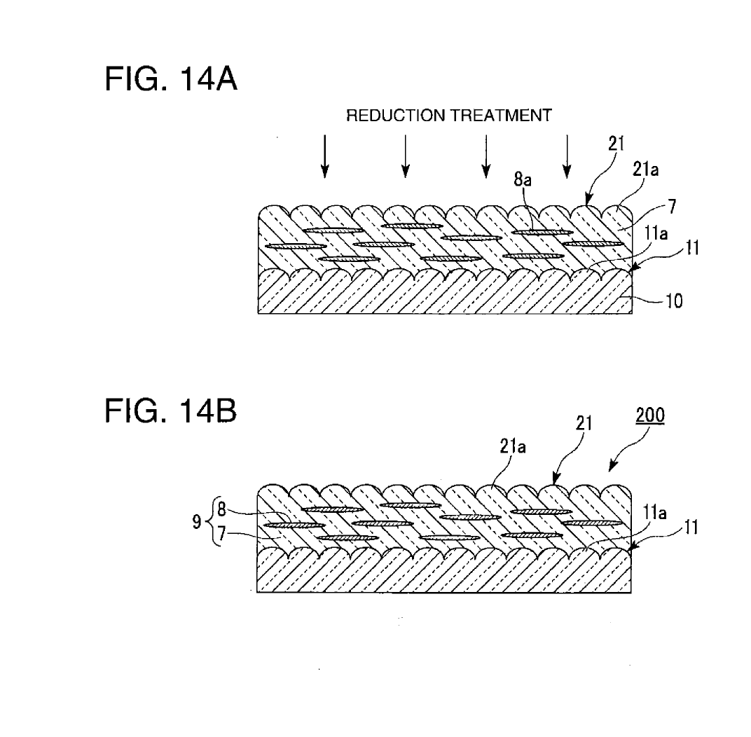

FIG. 13 is a flowchart of the method for producing a polarizing element according to this embodiment. FIGS. 14A and 14B are views schematically showing the reduction step.

As shown in FIG. 13, the method for producing a polarizing element according to this embodiment includes a moth-eye structure forming step S1, a dielectric thin film forming step S2′, a stretching step S3, and a reduction step S4.

In this embodiment, in the sputtering apparatus 101 shown in FIG. 11, as a sputtering gas, a gas containing a halogen gas and an inert gas such as Ar is introduced into a vacuum chamber 55, the interior of which is brought into a vacuum state by a vacuum pump, and a voltage is applied to targets 50 and 51 by high-frequency power supply units 54. In this embodiment, as the target 50, for example, Ag is used, and as the target 51, SiO₂ is used in the same manner as in the above-described embodiment. As the halogen gas, F₂, Cl₂, Br₂, or I₂ can be used.

Further, as the sputtering gas, a halide gas can be used alone or along with an inert gas such as Ar. The halide is not particularly limited, however, examples thereof include boron compounds such as BCl₃, BBr₃, and BF₃; fluorocarbon compounds such as CF₄ and C₂F₆; germanium compounds such as GeCl₄ and GeF₄; silicon compounds such as SiCl₄ and SiF₄; silane compounds such as SiHCl₃ and SiH₂Cl₂; NF₃, PF₃, SF₆, SnCl₄, TiCl₄, and WF₆.

In this embodiment, metal nanoparticles 5 dispersed in a dielectric thin film 20 formed by the dielectric thin film forming step S2′ are composed of, for example, a metal halide such as AgClx, AgF, AgBr, or AgI. Hereinafter, the case where as the metal nanoparticles 5, AgClx particles are formed will be described.

Here, the melting point of AgClx is about 450° C. On the other hand, the melting point of Ag is about 1000° C. Therefore, in this embodiment, the metal nanoparticles 5 can be easily stretched as compared with the case where the metal nanoparticles 5 are not halogenated (i.e., Ag). Specifically, in this embodiment, if the base material 10 is heated to 600 to 700° C., the shape-anisotropic particles 8a can be formed by easily stretching the metal nanoparticles 5 along with the base material 10.

Therefore, according to this embodiment, even in the case where Ag having a higher melting point than the base material 10 is used as the target 50, the metal nanoparticles 5 can be easily stretched along with the base material 10 in the stretching step S3 by halogenating the metal nanoparticles 5.

In this embodiment, subsequent to the stretching step S3, the reduction step S4 is performed.

In the reduction step S4, as shown in FIG. 14A, the shape-anisotropic particles 8a composed of AgClx dispersed in the dielectric layer 7 are heated in a reducing atmosphere. By doing this, as shown in FIG. 14B, the shape-anisotropic particles 8a are reduced to Ag, whereby the shape-anisotropic metal particles 8 are formed. The base material 10 is exposed to a reducing atmosphere at a temperature which is higher than about 250° C. but not higher than the annealing point of glass by about 25° C. for a period of time sufficient to develop a chemically reduced surface layer. In this embodiment, since the shape-anisotropic particles 8a are each covered with the dielectric layer 7, a thermal reduction treatment may be performed for a period of time such that a reduced surface layer is formed to the inside of the dielectric thin film 20.

It is efficient to use a hydrogen gas atmosphere as the reducing atmosphere. Another known reducing atmosphere such as an ammonia cracked gas atmosphere or a CO₂/CO mixed gas atmosphere may be used.

According to this production method, a polarizing element 200 having the polarizing layer 9 in which a plurality of shape-anisotropic metal particles 8 composed of Ag are dispersed in the dielectric layer 7 can be produced.

According to this embodiment, even in the case where a metal, which has a high melting point as it is and therefore is hardly stretched, is used, by forming halide particles as the metal nanoparticles 5, the metal nanoparticles 5 can be easily stretched along with the base material 10 at a relatively low temperature. Further, the shape-anisotropic metal particles 8 composed only of a metal can be easily and reliably produced by the reduction step S4. Therefore, since a metal material having a high melting point can be used, a polarizer suitable for the intended use can be produced.

### Liquid Crystal Display Device

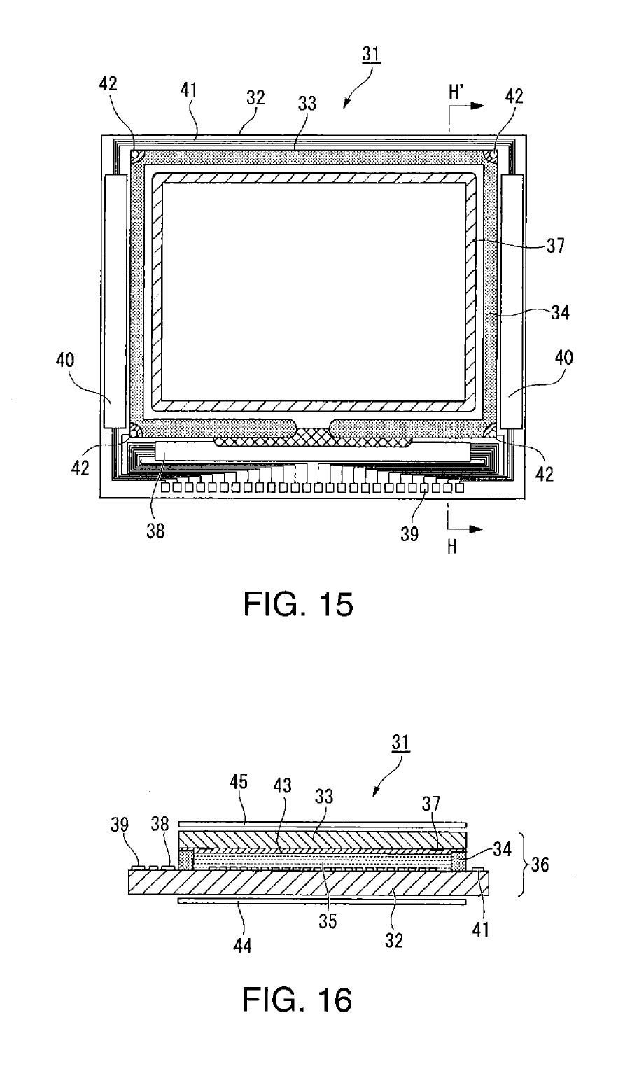

Hereinafter, a liquid crystal display device according to one embodiment of the invention will be described with reference to FIGS. 15 and 16.

In this embodiment, an active matrix type liquid crystal display device using a thin-film transistor (hereinafter abbreviated as “TFT”) as a pixel switching element is described by way of example. FIG. 15 is a plan view of a liquid crystal display device of this embodiment along with respective constituent elements as viewed from a counter substrate side, and FIG. 16 is a cross-sectional view taken along the line H-H′ in FIG. 15.

As shown in FIGS. 15 and 16, a liquid crystal display device 31 according to this embodiment includes a liquid crystal panel 36 in which a TFT array substrate 32 and a counter substrate 33 are bonded to each other with a sealing material 34, and a liquid crystal layer 35 is enclosed in a region defined by the sealing material 34. The liquid crystal layer 35 is composed of a liquid crystal material with positive dielectric anisotropy. In an area inside the region where the sealing material 34 is formed, a light shielding film (peripheral margin) 37 composed of a light shielding material is formed.

In a peripheral circuit region outside the sealing material 34, a data-line drive circuit 38 and external circuit mounting terminals 39 are formed along one side of the TFT array substrate 32, and scanning-line drive circuits 40 are formed along two sides adjacent to this side. A plurality of wires 41 for establishing connection between the scanning-line drive circuits 40 provided on both sides of the display region are formed along the remaining one side of the TFT array substrate 32. Further, an inter-substrate conductive material 42 for establishing electrical connection between the TFT array substrate 32 and the counter substrate 33 is arranged at each corner of the counter substrate 33.

On the surface of the counter substrate 33 on the side of the liquid crystal layer 35, a color filter 43 is formed. The color filter 43 has a red color material layer, a green color material layer, and a blue color material layer corresponding to a plurality of subpixels arranged in a matrix. On the light incident side and the light exit side of the liquid crystal panel 36, a polarizing plate 44 and a polarizing plate 45 are disposed, respectively. These polarizing plates 44 and 45 are the polarizing elements according to the above-described embodiment.

According to this embodiment, by providing the polarizing element according to the above-described embodiment, an antireflection function can be imparted, whereby a liquid crystal display device which enables bright and high contrast display, i.e., favorable display can be realized.

### Electronic Apparatus

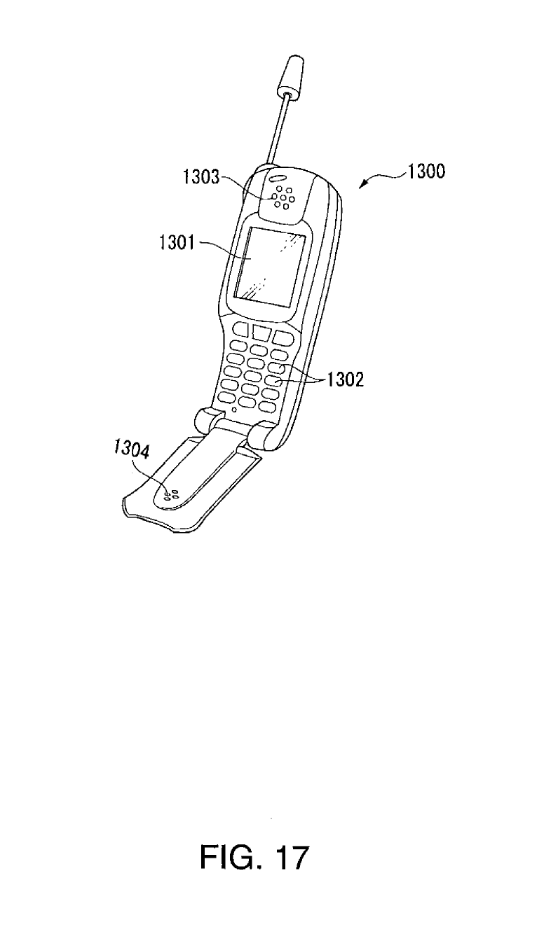

Hereinafter, one embodiment of an electronic apparatus according to the invention will be described with reference to FIG. 17.

FIG. 17 is a perspective view of a cellular phone provided with the liquid crystal display device according to the above-described embodiment. As shown in FIG. 17, a cellular phone 1300 (an electronic apparatus) includes a plurality of operation buttons 1302, an earpiece 1303, and a mouthpiece 1304, and also a display section 1301 composed of the liquid crystal display device according to the above-described embodiment.

According to this embodiment, by providing the liquid crystal display device according to the above-described embodiment as the display section 1301, an electronic apparatus including a liquid crystal display section having excellent display quality can be realized.

Specific examples of the electronic apparatus according to the invention include projectors, electronic books, personal computers, digital still cameras, liquid crystal televisions, view finder type or monitor direct viewing type video tape recorders, car navigation systems, pagers, electronic notebooks, electronic calculators, word processors, work stations, video phones, POS terminals, and electronic apparatuses provided with a touch panel as well as cellular phones described above.

The technical scope of the invention is not limited to the above-described embodiments, and various modifications can be made within a range not departing from the gist of the invention.

The entire disclosure of Japanese Patent Application No. 2013-064425, filed Mar. 26, 2013 is expressly incorporated by reference herein.

What is claimed is:

1. A method for producing a polarizing element, comprising:
forming a moth-eye structure on one surface of a base material;
forming a dielectric thin film, in which metal nanoparticles are dispersed, on the moth-eye structure of the base material; and
forming a polarizing layer on the base material by stretching the base material so as to stretch the metal nanoparticles thereby forming acicular metal particles.

2. The method for producing a polarizing element according to claim 1, wherein the metal nanoparticles are composed of a metal halide, and the method further comprises reducing the metal nanoparticles.

3. The method for producing a polarizing element according to claim 1, wherein in the formation of the dielectric thin film, a metal material and a dielectric material are simultaneously deposited on the base material.

4. A polarizing element, comprising:
a base material in which a moth-eye structure stretched in a given direction is formed on one surface thereof; and
a polarizing layer, which is formed on the moth-eye structure of the base material, and in which a plurality of acicular metal particles are dispersed in a dielectric material having light transmittance, wherein
the polarizing layer has a concavo-convex shape following the moth-eye structure on the surface thereof.

5. A liquid crystal display device, comprising:
a liquid crystal panel in which liquid crystals are sandwiched between a pair of substrates; and
a polarizing element disposed on at least one surface of the liquid crystal panel, wherein
the polarizing element is the polarizing element according to claim 4.

6. An electronic apparatus comprising the liquid crystal display device according to claim 5.
